(19) United States
(12) Patent Application Publication
(10) Pub. No.: US 2015/0159753 A1
(43) Pub. Date: Jun. 11, 2015

(54) CYLINDER BULKHEAD HOLDER

(71) Applicant: Peter A. Mueller, Gattikon (CH)

(72) Inventor: Peter A. Mueller, Gattikon (CH)

(21) Appl. No.: 14/117,237

(22) PCT Filed: May 9, 2012
(86) PCT No.: PCT/CH12/00102

§ 371 Date: Mar. 2, 2015

(30) Foreign Application Priority Data
May 9, 2011 (CH) 786/11
Jan. 5, 2012 (CH) 18/12

(51) Int. Cl. F16J 10/04; F16J 9/12

(52) U.S. Cl. CPC F16J 10/04; F16J 9/12

(57) ABSTRACT

The invention relates to an operating cylinder which includes a cylinder liner having one or more annular grooves incorporated into it, corresponding retainer rings or retainer ring segments fitting into said grooves and resting against the bulkheads or being forced against the cylinder liner or against the retainer rings or the retainer ring segments by means of the shaft nut owing to the beveled or fluted section. Means prevent any additional axial displacement of the bulkheads.

### TECHNICAL FIELD

The invention is based on an operating cylinder for machines of any kind with mounted end caps that are fastened by means of a retaining ring and a clamp disc according to the preamble of the first claim.

### PRIOR ART

Operating cylinders, irrespective of whether they are pneumatically, hydraulically or electrically operated, serve for moving and/or securing machine parts; they are well known in the art and used every day throughout the world, be this in the air, on the ground or under water.

The cylinder ends are either held in place by tie rods, or they are screwed together directly by means of a cylinder thread, or they are welded or shrunk together, whereby a leak-proof body is formed with a piston rod protruding from one or both cylinder ends, wherein the piston rod is correspondingly sealed in such a manner that at least one chamber of the cylinder can be maintained as sealed. The fluid is in most cases air or hydraulic oil. The cylinder includes at least one inlet piping connection for allowing a fluid to be supplied as well as discharged.

The same applies regarding electrical cylinders with regard to compressive and tensile forces that are in effect and act upon the end caps, and wherein the end caps must be dimensioned accordingly and must be in part water-proof.

Further known are cylinder-like shapes that serve as pressure accumulators; these are, most of the time, welded and have a gas-filled bladder that is disposed inside the cylinder, as disclosed according to EP 1 585 629 B1.

The cylinder ends are mechanical components of central importance on an operating cylinder, which is why these parts demand such a great deal of attention, and work is ongoing to find corresponding structural solutions, wherein paths toward such solutions are described, for example, in the patents JP 2001 295807 and U.S. Pat. No. 3,750,537.

### BRIEF DESCRIPTION OF THE INVENTION

The object underlying the present invention seeks to provide an operating cylinder, presently represented by way of a fluid cylinder, that is held in place only by means of a respective retaining ring as incorporated before the ending of the cylinder liner, and which secures the end caps, presently referred to a bulkheads, to prevent them from being forced toward the exterior and from being forced toward the interior by way of different means, and, at the same time, the respective bulkhead has a corresponding seal, whereby it is possible to obtain a sealing cylinder in this manner, and wherein at least one bulkhead includes an opening and a seal for a piston rod, and wherein, on the opposite bulkhead, it is possible to install a thread and a retaining means and/or a position-sensing element and/or a lift lock, and, in the case of a fluid operating cylinder, the two bulkheads include at least one fluid inlet piping connection.

In the past, and in part still today, a major part of operating cylinders, were connected to the cylinder liner by means of a tie rod, and included simultaneously inlet piping connections on the bulkheads. Nowadays, to save cost, the trend is toward providing cylinders where the bulkheads are provided by way of a screwed or welded connection. On some of the operating cylinders that are provided with screwed connections, the bulkheads are substantially larger than the cylinder liner in order to accommodate a number of radially provided long screws and the matching threads, thus taking up a great deal of space in terms of the total cross-section. With so-called compact operating cylinders, the fluid inlet piping connections are often welded into the cylinder liner, less frequently screwed thereto.

The present invention demonstrates that no welding steps are necessary for manufacturing a cylinder, and that the cylinder liner can be quickly and easily prepared for the final assembly in that an annular groove must only be incorporated on both ends of the cylinder liner, depending on the design and the force transmission, in the inside diameter or outside diameter; and, instead of a groove in the outer diameter, it is possible to locally upset and/or round knead the cylinder liner to thus create a collar, possibly a bead at the same time, whereby, due to the densification of the material, even a reinforcement for the cylinder liner is achieved.

The one bulkhead includes a bore and a seal pack for guiding the piston therein, as well as the fluid inlet, and the other bulkhead must accommodate the fastening lug, the fluid inlet and possibly a position sensing means and/or a lift lock and a thread for accommodating the shaft nut.

The advantage of this type of construction is the fact that these bulkheads can be completely machined and finished on the corresponding CNC machinery, without having to mind the cylinder liner or pay attention to the length of the cylinder liner. Instead of connecting a bulkhead to the cylinder liner by means of a plurality of long screws and nuts or a thread in the opposite bulkhead, a cost-effective retainer ring made of round wire is snapped in place in the annular groove of the cylinder liner.

This way, it is possible to push the finished bulkhead, which also includes a sealing ring, into the cylinder liner, which was previously cut to size, as far as to the retainer ring thus achieving a perfect fit. Then the piston rod is inserted together with the piston, or the bulkhead, piston rod and piston are jointly pushed into the cylinder liner. Then the other bulkhead is pushed in, followed by the retainer ring, then the bulkhead and the retainer ring are tightened relative to each other by a shaft nut. The bulkhead is beveled or fluted toward the side of the retainer ring, such that the same presses the retainer ring against the annular groove, when pressure is applied by the fluid, whereby, this way, a base area is created that is as large as possible for the surface pressure application on both sides of the retainer ring, thereby allowing for a harmonious pressure distribution on the cylinder liner.

This way, the cylinder represents a solid and sealed unit that can be offered as an assembly module; meaning, at a given diameter of the piston, the cylinder liner can be cut to length for the corresponding travel, or it can be placed on bearings of a corresponding number. The bulkhead, particularly the rear bulkhead, which can also include different retaining means and rotary bearing means, meaning ranging from a simple configuration to the high-value version with lift lock and position sensing means, the logistical supply has been rendered less complex, and a cylinder can thus be very quickly constructed and/or assembled. Such a solution according to the invention does not include welding seams, which is particularly advantageous in terms of welded part corrosion for applications offshore. In contrast to the tie rod technique, regarding diameter, the cylinder is smaller in terms of solid mass, is able to absorb greater forces and still has a lower weight. Using caps that are, if so desired, designed in color and can be labeled, advantageously fabricated from plastic, it is possible to avoid any impression of the front bulkhead against a pressureless cylinder, the retainer rings are protected against rough dirt and, if necessary, the bulkhead can be used to create an elegant cover for the hose connection.

In terms of a structural solution, the solution for the operating cylinder is also suited for use in connection with telescopic cylinders and can be taken over in identical form. For a piston with pressure applied on one side only, the varying air chamber can be kept clean by means of a hydrophobic air filter or a bellows, in that no dust and also no water is able to penetrate to the inside of the cylinder, while still maintaining a pressureless air chamber.

Mounting a large retainer ring, which is typically associated with a great spring force, is possibly difficult and perhaps difficult to insert or at least to remove again. In such a case, the retainer ring is subdivided into segments, such that the segments are consecutively, one after the other, inserted in the annular groove, whereby the functionality of the retainer ring as an axial limiting means of the bulkhead continues to be ensured, while simultaneously providing for easy assembly and disassembly. The bulkhead includes a protrusion such that, following the installation of the bulkhead in the cylinder liner, the individual segments cannot fall out, meaning they are thus radially secured.

Therefore, the technical solution for cylinders can be a cost-effective while still providing a fast and abundantly variable solution for bladder accumulators, particularly in that the bulkheads ensure that the bladder is securely stored inside the cylinder and, should repair work become necessary, the different parts of a bladder accumulator are easily opened, reclosed and sealed.

According to the invention, this object is achieved with the characterizing features of the first claims.

Further advantageous configurations of the invention can be derived from the dependent claims.

The core of the present invention provides for using two bulkheads, that fulfill all of the functions of an operating cylinder or a bladder accumulator or similar cylinder-specific tasks, pushing the same into a cylinder liner, wherein the cylinder liner includes, on the interior or on the exterior, an annular groove or a collar with a bead, respectively, whereby it is possible to clip a retainer ring thereto or insert segments of a retainer ring therein, and whereby any undesired displacement of the bulkheads toward the outside is safely prevented; the invention also provides that a pressurized operating cylinder is safely fastened by means of a central shaft nut to the bulkhead.

### SHORT DESCRIPTION OF THE DRAWINGS

Embodiments of the invention will be explained in further detail below based on the drawings. Same elements in different figures are identified by identical reference symbols.

Shown are as follows:

FIG. 1 is a representation of a side view of an operating cylinder with the bulkheads in the cylinder liner, the annular grooves and shaft nut disposed therein, the retainer rings, the radial seals, the two caps, the fastening lug, the fluid inlet piping connection and the piston rod with the piston thereof and the front fastening lug;

FIG. 2 is a representation of a side view of an operating cylinder with the bulkheads above the cylinder liner, the exterior annular grooves and shaft nut, the retainer rings, the radial seals, the fastening lug, the fluid inlet piping connection and the piston rod with piston and the front fastening lug;

FIG. 3 is a representation of a side view of an operating cylinder with the bulkheads in the cylinder liner, the annular grooves and shaft nut disposed therein, the retainer rings, the radial seals, the axial snap ring, the fastening lug, the fluid inlet piping connection and the piston rod with piston and the front fastening lug;

FIG. 4 is a representation of a side view of a part of an operating cylinder with the rear bulkhead and the fastening lug in the cylinder liner, the annular grooves and the shaft nut disposed therein, the retainer rings, the radial seals and the spacer;

FIG. 5 is a representation of a side view of a bladder accumulator cylinder with the bulkheads in the cylinder liner, the annular grooves and shaft nut disposed therein, the retainer rings, the radial seals, the axial snap ring, the bladder as well as the locking valve and the filling connection;

FIG. 6 is a representation of a front view of an operating cylinder with the cylinder liner and the segmented retainer ring disposed therein, as well as two variants of disassembly aids;

FIG. 7 is a representation of a side view of an operating cylinder in the telescopic configuration with the bulkheads in the cylinder liner, the annular grooves and shaft nut disposed therein, the retainer rings, the radial seals, the fastening lug, the fluid inlet piping connection, the guided first piston rod with the piston guide and the final stop, as well as the second piston rod with the piston thereof and the front fastening lug, and an air filter and/or bellows.

Shown are only those elements that are essential for an immediate understanding of the invention.

### WAYS FOR EMBODYING THE INVENTION

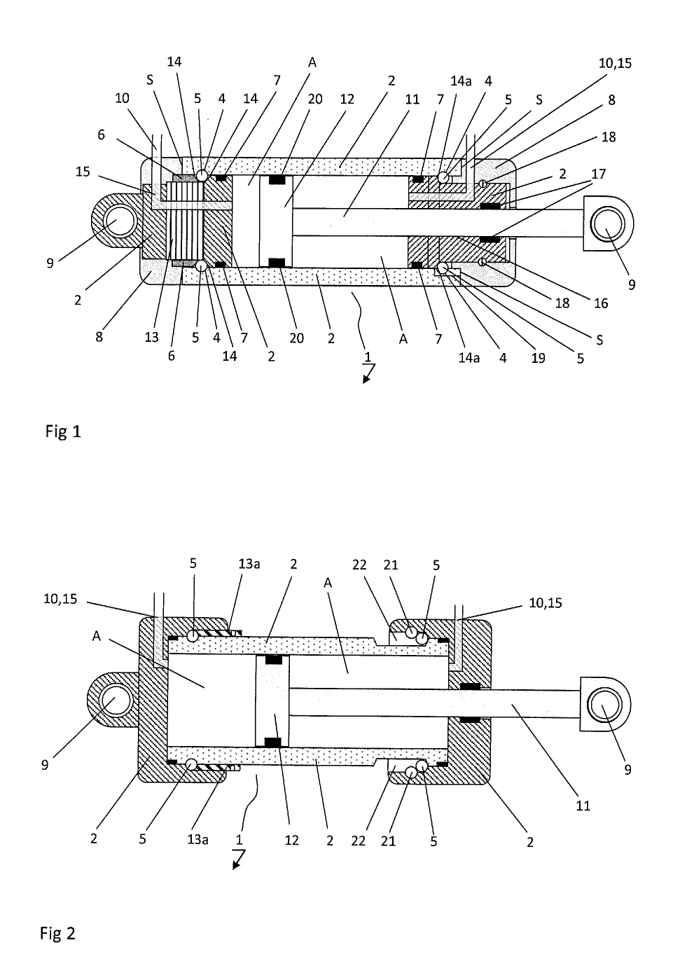

FIG. 1 is a representation of a side view of an operating cylinder 1 with the bulkheads 2 inside the cylinder liner 3, the annular grooves 4 disposed therein, the retainer rings 5, the shaft nut 6, the radial seals 7, the two caps 8, the fastening lugs 9, the fluid inlet piping connection 10 and the piston rod 11 with the piston 12.

A cylinder liner 3 that has been cut to the desired length is provided with an annular groove 4 on both sides, which is created by chip removal or by impression of the groove mold, wherein the latter has the advantage that the material is compacted whereby the course of the fibers is not interrupted causing the annular groove to withstand higher loads. The selected form of the annular groove 4 is of central importance and shall correspond to the cross-section of the round wire of the retainer ring 5 in a much as possible, wherein sharp edges must be avoided during production. This is why a circlip should not be used for such high-load functional parts, as this can result in the formation of tears in the corners of such a groove. The bulkhead 2 can be completely machined in a single mount; for example, the rear bulkhead 2 from the fastening lug 9 via the thread 13 for the shaft nut 6, the beveling 14 or fluting 14a for better contact action relative to the retainer ring 5, the recess for the radial seal 7, to the fluid bore 15 and the, presently not shown, cavity for technical means, such as, for example, for position sensing, lift locking means. The front bulkhead 2 can also be produced on a mount that contains the piston rod bore 16 and sealing grooves 17a for the diverse seals of the piston rod 11 presently not shown in detail as well as the recess for the radial seal 7 and fluid bore 15 and possibly a groove for a snapping means 18 for anchoring the cap 8.

The assembly of such an operating cylinder 1 is therefore extremely easy in that, for example, the retainer ring 5 is inserted in the front annular groove 4. A small longitudinal groove 19 is also disposed at there, allowing for the detachment of the retainer ring 5 from the engagement therein at any time once again by the use of a corresponding instrument. The front bulkhead 2 is introduced, for example, from behind into the cylinder liner 3 and pushed into the liner until the stop point on the retainer ring 5. The beveling 14, which can also include a corresponding fluting 14a, later pushes against the bulkhead 2, when pressure is applied to the fluid, pressing against the retainer ring 5, which is a round wire and thereby distributes the surface pressure into the rounding of the annular groove 4. The radial seal 7 prevents the fluid from leaking from the cylinder liner 3.

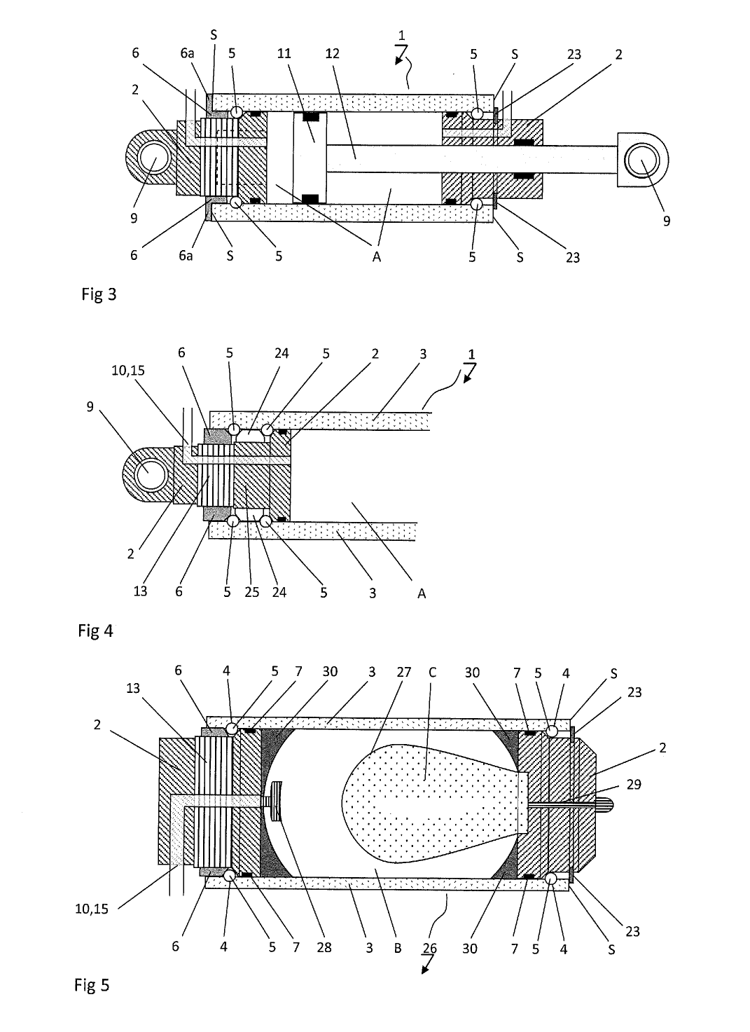

The piston rod 11 with the piston 12 and the piston seal 20 are then pushed into the cylinder liner 3, then the rear bulkhead 2 with the radial seal 7 is pushed in, and then the retainer ring 5 is inserted in the annular groove 4. For the operating cylinder 1 to be able to absorb tensile and compressive forces, the rear bulkhead 2 includes a thread 13, whereby the shaft nut 6 can be screwed onto the thread 13 pressing by the beveling 14 or fluting 14a thereof against the retainer ring 5, simultaneously pulling the bulkhead 2 with the beveling and/or fluting 14a thereof against the retainer ring 5. Or the shaft nut 6 includes an exterior shoulder 6a, as shown in FIG. 3, thereby pressing the shaft nut 6 against the shoulder edge S of the cylinder liner 3, wherein the thread 13 pulls the bulkhead 2 against the retainer ring 5. This way, the operating cylinder 1 is play-free and is able to absorb forces in both lift directions. Then the cap 8 is installed that protects the thread 13 against soiling and possibly covers up the, presently not shown, hose connection to the fluid inlet piping connection 10. The front cap 8 also serves to keep dirt away from the area of the retainer ring 5, possibly for covering up the hose connection, but particularly for securing the bulkhead 2, so that, when the operating cylinder 1 is held pressureless, it cannot be pushed into the piston chamber A, particularly in that the cap 8 supports itself against the shoulder S of the cylinder liner 3.

FIG. 2 shows a side view of an operating cylinder with the bulkheads 2 over the cylinder liner 3, the exterior annular grooves 4 and threaded ring 13a, the retainer rings 5, the radial seals 7, the fastening lugs 9, the fluid inlet piping connection 10 and the piston rod 11 with the piston 12 and the front fastening lug 9.

The connection principle of the cylinder liner 3 with the bulkhead 2 is identical to the principle in FIG. 1, with the sole difference that the annular groove 4 is disposed on the exterior of the cylinder liner 3 to provide more space inside the operating cylinder 1 while maintaining the same structural length but giving the operating cylinder 1 a somewhat larger outside diameter. This construction precludes that the bulkhead 2 is forced into the piston chamber A. This version shows two different connection options for the bulkhead 2 with the cylinder liner 3; namely, the rear bulkhead 2 is pushed onto the cylinder liner 3 until reaching the retainer ring 5, and the previously pushed-on threaded ring 13a, which has an external thread, and the bulkhead 2, which has an internal thread, are then screwed in against the retainer ring 5 and connected, whereby a play-free connection is obtained. The front bulkhead 2 is also pushed on the cylinder liner 3 until reaching the retainer ring 5, and whereafter the snap retainer ring 21, which can be identical to the retainer ring 5 except for the fact that the latter has a larger diameter, is snapped on thereby preventing any axially outward pushing action of the bulkhead 2 from the cylinder liner 3. This externally disposed connecting structural assembly is predestined in series production for upsetting of the cylinder liner 3 in that, instead of inserting the retainer ring 5, a collar is formed on the cylinder liner 3 using an upsetting forming method, and additionally, using, for example, a rotary kneading method, a bead 22 is formed, whereby the snap retainer ring 21 can be detached from the bulkhead 2 at any time. Upsetting and rotary kneading increase the solidity of the material in support of the safety considerations with regard to the connection between the bulkhead 2 with the cylinder liner 3. Another option for applying a collar to the cylinder liner 3 is the use of a shrink method or, for cylinder applications without exposure to major corrosion, the collar can be applied, for example, by friction welding.

FIG. 3 is a representation of a side view of an operating cylinder 1 with the bulkheads 2 inside the cylinder liner 3, the annular grooves 4 and shaft nut 6 disposed therein, the retainer rings 5, the radial seals 7, the axial snap ring 23, the fastening lug 9, the fluid inlet piping connection 10, the piston rod 11 with the piston 12 and the front fastening lug 9 as well as the shoulder 6a on the shaft nut 6.

The structural assembly is identical to the structural assembly as illustrated in FIG. 1, except for the fact that, instead of the front cap 8 preventing the bulkhead 2 from being pushed into the piston chamber A, this axial displacement of the bulkhead into the piston chamber A is prevented, in particular, with the aid of an axial snap ring 23, which is, for example, a simple circlip, or a further retainer or a retaining clamp, by providing the bulkhead 2 with a groove where the axial snap ring 23 can be snapped in place and can be supported against the shoulder edge S of the cylinder liner 3. As described previously in FIG. 1, in this version, the shaft nut 6 includes a shoulder 6a, whereby, when screwing in the shaft nut 6 onto the bulkhead, the bulkhead is pulled toward the retainer ring 5, with the shoulder 6a supporting itself against the safety edge S of the cylinder liner 3.

FIG. 4 is a representation of a side view of a portion of an operating cylinder 1 with the rear bulkhead 2 and the fastening lug 9, the cylinder liner 3 with the annular grooves 4 disposed therein and the shaft nut 6, the retainer rings 5, the radial seal 7 and the intermediate piece 24.

At high loads and spatial constraints, it is possible to reinforce the connection between the bulkhead 2 and cylinder liner 3 by extending the bulkhead 2 in order for it to accommodate the intermediate piece 24, which is pushed thereon via the cylindrical part, the extension 25. In this context, the cylinder liner 3 includes two annular grooves 4 on the cylinder end instead of only one, as in the preceding versions. The bulkhead 2 is correspondingly pushed into the cylinder liner 3 until behind the first annular groove 4, then the retainer ring 5 is inserted, then the intermediate ring 24 is pushed on the bulkhead 2, and then the next retainer ring 5 is inserted in the second annular groove 4, after which point the shaft nut 6 is placed on the thread 13, and the entire construct is tightened, wherein, due to the beveling 14 or fluting 14a on the bulkhead 2 and on the intermediate piece 24 as well as on the shaft nut 6, the retainer rings 5 are forced against the annular grooves 4, thereby generating a homogeneous pressure distribution in the annular grooves 4 of the cylinder liner 3. This way, the operating cylinder 1 is provided with double the support between the bulkhead 2 and the cylinder liner 3.

The assembly can also be implemented in another way, particularly in that the bulkhead 2 is completely pushed into the cylinder liner 3, especially by a defined amount, together with the intermediate piece 24 and the two retainer rings 5, which rest in the beveling 14 or fluting 14a by a small diameter, and the shaft nut 6. The shaft nut 6 is then tightened thereby spreading the retainer rings 5, owing to the beveling 14 or fluting 14a, which are tightly forced into the opening of the annular grooves 4 against the cylinder liner 3 depending on the torque that is used for tightening the shaft nut 6. Conceivably, further intermediate pieces 24 with the associated retainer rings 5 and annular grooves 4 can be placed, and whereby the retainer rings 5 require diverging dilatation forces to avoid that all retainer rings are radially impressed into the annular groves 4 at the same time.

The connection modality of the bulkhead 2 to the cylinder liner 3 can also be utilized for the front bulkhead 2.

The retainer rings 5 can also be configured for inside dimension, meaning the retainer rings 5 rest upon the smallest diameter of the bulkhead 2. The respective bulkhead 2 is pushed into the cylinder liner 3 as part of a group together with the one or multiple retainer rings 5 and the shaft nut 6 that is placed on the thread 13. It is possible to provide a small step in the cylinder liner 3 in advance that serves as an assembly aid, whereby the group makes contact at the desired location and is thereby correctly positioned. By screwing in the shaft nut 6, and due to the beveling 14 and/or fluting 14a, the one or multiple retainer rings 5 is/are dilated pressing themselves into the respective annular grooves 4 creating a play-free connection between the bulkhead 2 and the cylinder liner 3.

FIG. 5 is a representation of a side view of a bladder accumulator cylinder 26 with the bulkheads 2 inside the cylinder liner 3, the annular grooves 4 disposed therein and the shaft nut 6, the retainer rings 5, the radial seals 7, the axial snap ring 23, the bladder 27 as well as the locking valve 28 and the filling connection 29 and interior lining 30.

The advantage of the easy manufacture of an operating cylinder 1 by means of the aforementioned structural assembly is also usable in other cylinder applications, such as, for example, a bladder accumulator cylinder 26 that is without welding seam for this purpose, and whereby various bladder sizes can be safely, quickly and easily implemented.

The construction of the bladder accumulator cylinder 26 is similar to the construction of the operating cylinder 1 as shown in FIG. 4; instead of on the front bulkhead 2 of a piston rod bore 16, a filling connection 29 is mounted at this point where the bladder 27 is fastened, and there is the interior lining 30, which has a rounded shape such that, when the bladder 27 is completely filled, said bladder is able, in as much as this is possible, to optimally lie inside the cylinder liner 3. The interior lining 30 and the inside of the operating cylinder 1 can also be lined with a coating to prevent the bladder 28 from adhering to the operating cylinder 1 by the exterior side thereof. It is known in the art to envision hydraulic oil inside the chamber B, while the bladder 27, chamber C, contains a pressurized gas. To ensure that, when filling the bladder 27, said bladder and the bulkhead do not fall into the cylinder liner 3, in this instance as well, an axial snap ring 23 is installed. The other bulkhead 2 is disposed on the opposite side, which includes a locking valve 28 and contains the fluid inlet piping connection 10 as well as the fluid bore 15. The bulkhead 2 is also mounted by means of the retainer ring 5 inside the annular groove 4, with the whole construct being held in place by means of the shaft nut 6, which presses against the retainer ring 5. Sealing the fluid against the ambient environment is also achieved by the radial seals 7 on both bulkheads 2. The retaining means on the bulkhead 2 for mounting the bladder accumulator cylinder 26 in lying or upright position on the hydraulic unit is not depicted.

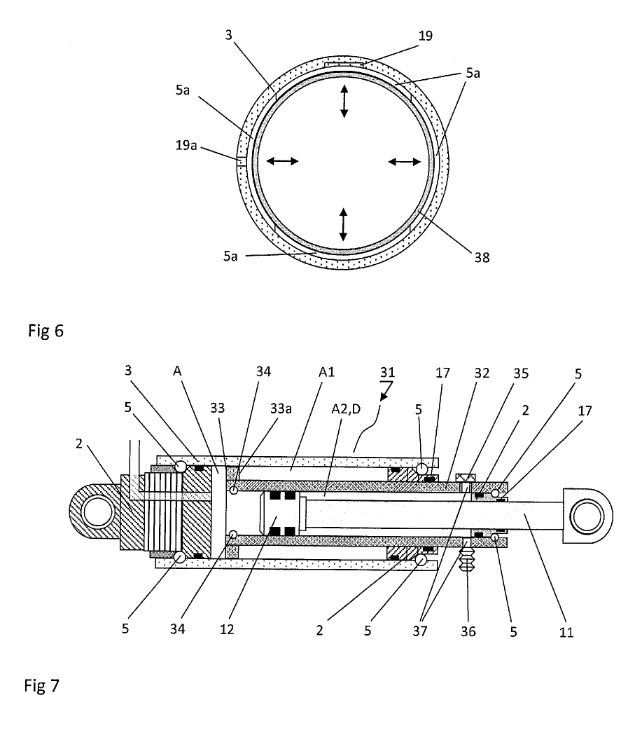

FIG. 6 is a representation of a front view of an operating cylinder 1 with the cylinder liner 3 and the retainer ring segments 5a that are mounted therein.

The assembly of a retainer ring 5 is possibly not that easily accomplished, particularly with strong wires that are difficult to compress. The use of a circlip is a favored option for this reason; however, at high loads, the circlip will destroy the cylinder liner 3. This problem is elegantly solved by providing the retainer ring with segments 5a. Two variants are particularly beneficial for this purpose; on the one hand, the variant that envisions retainer rings 5 that are cut in one direction, whereby the thus resulting retainer ring segments 5a can be easily assembled and disassembled following the direction of the arrows. To this end, two retainer ring segments 5a with different cuts are necessary. For the second variant, all the retainer ring segments 5a are identical and cut in such a manner that the cut approximately points to the center of the cylinder liner 3. The disadvantage is presently that quite a large gap is needed, or such a gap is at least necessary between two retainer ring segments 5a, for installing and removing the individual retainer ring segments 5a.

A conceivable disassembly aid is, on the one hand, the longitudinal groove 19 or, on the other hand, the disassembly bore 19a by which the correspondingly retainer ring segment 5a can be forced out of its position using a pin.

Normally, this bulkhead 2 includes a nose where, for example, the piston rod seal 17 is disposed or, in the extension, the thread 13, whereby, when pushing the bulkheads 2 into the retainer ring segments 5a, the nose holds the same in radial position. If this nose is omitted, the retainer ring segments are advantageously secured by means of a retaining ring 38 or generally use the same as an assembly aid.

FIG. 7 is a representation of a side view of an operating cylinder 1 designed as a telescopic cylinder 31 with the bulkheads 2 inside the cylinder liner 3, the annular grooves 4 disposed therein and the shaft nut 6, the retainer rings 5, the radial seals 7, the fastening lugs 9, the fluid inlet piping connection 10, the guided telescopic piston rod 32 with the piston guide 33, the internal lift limiting means 34 and the second, commonly found standard piston rod 11 with the piston 12, the front fastening lug 9 and an air filter means 35 or bellows 36, respectively.

The embodied structural assembly ads shown in the preceding depictions in FIGS. 1-4 and in FIG. 6 can be transferred to the application of the telescopic cylinder 31 as well, wherein a telescopic piston rod 32 is added and a piston guide 33 serves as guiding means for said telescopic piston rod. On the outwardly oriented side of the telescopic piston rod 32, there is disposed a bulkhead 2, and on the opposite side there is a lift limiting means 34 installed, resulting in the lift action of the piston rod 11 inside the telescopic piston rod 32 to be correspondingly limited.

In a unilaterally hydraulically pressurized telescopic cylinder 31, the hydraulic oil is supplied into the piston chamber A, and the surface areas of the piston 12 plus the piston guide 33, minus the interior piston side 33a are in effect as force areas during the pressurization by the hydraulic oil. Although the piston chamber A1 reduces the maximum force of the telescopic cylinder 31, it simplifies, however, the manufacture of the product.

An air chamber D forms regarding piston chamber A2 that is without the inflow of hydraulic oil in this configuration with a sealed piston 12. If the piston rod 11 has still another piston rod seal on the bulkhead 2, it is advantageous for the air not to compressed during the extension operation of the piston 12, and for the absence of a vacuum formation in the air chamber D, when the piston 12 is retracted. This is why a passage 37 is provided on the telescopic piston rod 32 or the there-located bulkhead 2, where a hydrophobic air filter 35 or a bellows 36 can be disposed, wherein the bellows can also be mounted at an advantageous location by means of a line, and whereby it is possible for the air in the air chamber D can be moved as an air column, quasi pressureless.

Depending on the configuration of the telescopic cylinder 31, it is possible to incorporate a plurality of telescopic pistons 32 with correspondingly different diameters, whereby it is possible to generate a very long lift by means of a quite modest length of a cylinder liner 3.

It is understood that the invention is not limited to the illustrated and described embodiments.

### LIST OF REFERENCE SIGNS

1 Operating cylinder
2 Bulkhead
3 Cylinder liner
4 Annular groove
5 Retainer ring
5a Retainer ring segment
6 Shaft nut
6a Shoulder
7 Radial seal
8 Cap
9 Fastening lug
10 Fluid inlet piping connection
11 Piston rod
12 Piston
13 Thread
13a Thread ring
14 Beveling
14a Fluting
15 Fluid bore
16 Piston rod bore
17 Piston rod seal
17a Sealing groove
18 Snapping means
19 Longitudinal groove
19a Disassembly bore
20 Piston seal
21 Snap retaining ring
22 Bead
23 Axial snap ring
24 Intermediate piece
25 Extension
26 Bladder accumulator cylinder
27 Bladder
28 Locking valve
Filling connection
30 Interior lining
31 Telescopic cylinder
32 Telescopic piston rod
33 Piston guide
33a Interior piston side
34 Lift limiting means
35 Air filter means
36 Bellows
37 Passage
38 Retaining ring
A, A1, A2 Piston chamber
B Hydraulic oil chamber
C Gas chamber
D Air chamber
S Shoulder edge

1. An operating cylinder
wherein
the operating cylinder comprises a cylinder liner in which are disposed one or a plurality of interior or exterior annular grooves or beads that accommodate retainer rings or retainer ring segments, which rest against the bulkheads that include a beveling or fluting, or
in that the bulkheads are forced against the retainer rings or the retaining ring segments by means of the shaft nut, and in that the shaft nut presses against the retainer rings, or in that the shoulder 6a presses against the shoulder edge of the cylinder liner, or
in that the retainer rings are disposed against the inner diameter of the bulkheads spreading themselves apart, due to the nut being screwed onto the thread, and being forced into the annular groove,
and in that by means of the shaft nut or cap or axial snap ring any axial displacement of the bulkheads toward the inside of the operating cylinder is prevented, or in that a snap retaining ring on the bulkhead prevents any outward axial displacement of the bulkhead.

2. The operating cylinder according to claim 1,
wherein
the bulkheads comprise further technical means, which are a radial seal and a fluid inlet piping connection and piston rod bore and sealing groove and/or longitudinal groove and/or bead and/or fluid bores and/or thread and/or air filter means or bellows and/or measurement means and/or lift lock and/or final layer dampening.

3. The operating cylinder according to claim 2,
wherein
the fluting approximately corresponds to the cross-sectional profile of the round wire of the retainer ring, and/or in that the respective annular groove is hollow turned or rotary pressed corresponding approximately to the cross-sectional profile of the round wire of the retainer ring.

4. The operating cylinder according to claim 1,
wherein
the serially inserted retainer rings have diverging clamping forces.

5. The operating cylinder according to claim 1,
wherein
a plurality of annular grooves are disposed on each side of the cylinder liner that have retainer rings inserted therein, and in that an intermediate piece is disposed between these retainer rings, respectively.

6. The operating cylinder according to claim 1,
wherein
a collar and a bead are formed on the exterior of the cylinder liner.

7. The operating cylinder according to claim 1,
wherein
the operating cylinder is a fluid cylinder or an electric spindle cylinder or an accumulator means in form of a membrane, bladder or piston accumulator.

8. The operating cylinder according to claim 1,
wherein
the operating cylinder constitutes a telescopic cylinder including one or a plurality of telescopic piston rods.
